(19) United States
(12) Patent Application Publication
(10) Pub. No.: US 2016/0205918 A1
(43) Pub. Date: Jul. 21, 2016

(54) WEED ERADICATION METHOD AND APPARATUS HAVING LIGHT REDIRECTOR

(71) Applicant: Elwha LLC, Bellevue, WA (US)

(72) Inventors: Alistair K. Chan, Bainbridge Island, WA (US); William D. Duncan, Mill Creek, WA (US); Phillip A. Eckhoff, Kirkland, WA (US); Roderick A. Hyde, Redmond, WA (US); Jordin T. Kare, San Jose, CA (US); Keith D. Rosema, Olympia, WA (US); Lowell L. Wood,, JR., Bellevue, WA (US)

(73) Assignee: Elwha LLC, Bellevue, WA (US)

(21) Appl. No.: 14/598,072

(22) Filed: Jan. 15, 2015

(51) Int. Cl. A01M 21/04; F21V 33/00; A01G 1/00; F21V 14/04

(52) U.S. Cl. CPC A01M 21/04; F21V 14/04; F21V 33/006; A01G 1/001; F21W 2131/10

(57) ABSTRACT

A plant material targeting apparatus includes a light source platform and a light source coupled to the light source platform. The light source is configured to provide a high-intensity light. The apparatus also includes a light transmitter coupled to the light source. The light transmitter is configured to transmit the high-intensity light to a light redirector. In addition, the apparatus includes a light redirection platform separate from the light source platform. The light redirector is coupled to the light redirection platform. The light redirector is configured to receive the high-intensity light from the light transmitter and redirect the high-intensity light toward a plant material target to damage the plant material target. The apparatus further includes a control system that is configured to receive information representative of the location of the plant material target. The control system is also configured to provide a control signal to the light redirector to cause redirection of the high-intensity light to the plant material target.

### CROSS-REFERENCE TO RELATED APPLICATION

This application is related to U.S. application Ser. No. ______, (Attorney Docket No. 103315-0267), titled “WEED ERADICATION METHOD AND APPARATUS,” filed Jan. 15, 2015, which is incorporated herein by reference in its entirety.

### BACKGROUND

In commercial environments, weeds can outgrow useful crops, thereby stealing water and nutrients meant for the crops. Some weeds may also grow tall enough to obstruct light from crops, and their height further enables their seedpods to be unobstructed when they burst, thereby allowing the seeds to be wind-cast over large areas. As a result, weeds may not merely negatively affect a farmer's productivity every year, but may potentially, if left unchecked, completely overwhelm a field.

Weed control accounts for, in many instances, a large proportion (e.g., up to approximately 30%) of the cost of growing crops. Selective physical destruction of weeds is effective but highly labor intensive. Bulk physical destruction (e.g., plowing) is not always feasible (e.g., due to an existing crop) and may be destructive to soils (e.g., by causing erosion). Various chemicals (e.g., herbicides) are also often used to control weeds. However, chemical means to kill and control weeds are not a panacea. For example, resistance to frequently used herbicides is growing. In addition, a large segment of the market prefers non-chemically treated (e.g., “certified organic”) crops.

### SUMMARY

One embodiment relates to a plant material targeting apparatus. The apparatus includes a light source platform and a light source coupled to the light source platform. The light source is configured to provide a high-intensity light. The apparatus also includes a light transmitter coupled to the light source. The light transmitter is configured to transmit the high-intensity light to a light redirector. In addition, the apparatus includes a light redirection platform separate from the light source platform. The light redirector is coupled to the light redirection platform. The light redirector is configured to receive the high-intensity light from the light transmitter and redirect the high-intensity light toward a plant material target to damage the plant material target. The apparatus further includes a control system that is configured to receive information representative of the location of the plant material target. The control system is also configured to provide a control signal to the light redirector to cause redirection of the high-intensity light to the plant material target.

Another embodiment relates to a method of eradicating unwanted plants. The method includes identifying a location of a plant material target. The method also includes providing a high-intensity light from a light source coupled to a light source platform. In addition, the method includes receiving the high-intensity light from the light source by a light redirector coupled to a light redirection platform. The method further includes receiving a control signal by the light redirector. The control signal is based on the location of the plant material target. Further, the method includes redirecting the high-intensity light toward the plant material target based on the control signal. The high-intensity light is configured to damage the plant material target.

Another embodiment relates to an apparatus for eradicating unwanted plants. The apparatus includes a means for identifying a location of a plant material target. The apparatus further includes a means for providing a high-intensity light from a light source coupled to a light source platform. In addition, the apparatus includes a means for receiving the high-intensity light from the light source by a light redirector coupled to a light redirection platform. Further, the apparatus includes a means for receiving a control signal by the light redirector. The control signal is based on the location of the plant material target. Further yet, the apparatus includes a means for redirecting the high-intensity light toward the plant material target based on the control signal.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic of a plant material targeting apparatus according to one embodiment.

FIG. 2 is a schematic of a plant material targeting apparatus according to another embodiment.

FIG. 3 is a schematic of a plant material targeting apparatus according to another embodiment.

FIG. 4 is a schematic of a plant material targeting apparatus according to another embodiment.

FIG. 5 is a block diagram of a control system for a plant material targeting apparatus according to one embodiment.

FIG. 6 is a schematic of a plant material targeting apparatus according to another embodiment.

FIG. 7 is a flow diagram of a method of eradicating and controlling weeds according to one embodiment.

FIG. 8 is a flow diagram of a method of eradicating and controlling weeds according to another embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Weed control is an essential part of all agricultural systems, including food crop production systems (e.g., corn, maize, soybeans, silage, wheat, oats, rye, barley, flax, oilseed, fiber, vegetables, fruit, nuts, seeds, etc.), non-food crop production systems (e.g., flowers, ornamental plants, etc.), and non-crop plant growth (e.g., native and non-native decorative plants, etc.). Unwanted plants (e.g., weeds) reduce yields by competing with crops and non-crop plants for water, nutrients, and sunlight, and may directly reduce profits by hindering harvest operations, lowering crop quality, and producing chemicals which are harmful to plants (e.g., via allelopathy). Left uncontrolled, weeds may harbor insects and diseases and produce seed or rootstocks which infest the field and affect future crops. Despite large expenditures for weed control, it is estimated that losses in U.S. crops due to weeds left uncontrolled exceed $8 Billion annually.

Therefore, it is desirable to control and/or eradicate weeds in fields. Control generally involves attacking the weeds in such a way as to prevent the weeds from competing with the crops for sunlight, water, nutrients, and other resources. Eradication generally refers to the removal of weeds and/or weed seeds from a field so that the weeds will not reemerge year-over-year unless they are reintroduced to the field. Weeds may be eradicated in various ways, such as by consistently preventing a buildup of weed seed in the soil, particularly new weeds whose seeds are not already in the soil. As used herein, “crops” refer to desirable (e.g., planted) species and “weeds” refer to undesirable (e.g., non-planted) species.

The ultimate goal regarding weed control is a long-term reduction in the reappearance of weeds. It may therefore be beneficial to use various advanced weed control mechanisms, such as high resolution, minimal mechanical, optical, chemical or biological means, or some combination thereof, to control weeds. One approach may be to kill and re-kill, or damage and re-damage the weeds, in some regular manner, to help prevent a generation of weeds from successfully reproducing.

In some embodiments, various imaging and/or remote sensing techniques (e.g., multi-spectral or spectrometric techniques) may also be used to control and/or assess eradication (e.g., via phenotyping) before, during, and after a treatment of an area. The assessment may provide knowledge about the effectiveness of the control and/or eradication treatment. In addition, the assessment may indicate where re-treatment may be necessary.

High resolution imaging and/or remote sensing, for example, from unmanned aerial vehicles (UAVs), close-to-ground robots, and/or other vehicles, may be used to distinguish weeds from crops on a plant-by-plant basis, and to localize the weeds at high (e.g., centimeter-level) accuracy. Imaging sensors, combined with suitable analysis software, may distinguish between weeds and crops based on, for example, size, shape, location, and color of overall plants or specific parts (e.g., leaves or seed pods) of plants. Multi-spectral or hyperspectral imaging techniques, or non-imaging spectrometry plus conventional imaging, may be used to provide additional information, particularly with respect to the health and condition of plants or plant parts such as seedpods. Spectrometric techniques may be passive (e.g., using available light) or active (using a separate light source to illuminate the object). It may also be beneficial to use such techniques to identify and localize the weeds' seedpods and to further identify their age to determine when the seedpods are mature enough to burst and sow the seeds of the next generation of weeds.

Modern farms often use satellite navigation systems, such as the Global Positioning System (GPS), the Global Navigation Satellite System (GLONASS), and/or local precision navigation systems to control planting, harvesting, and other farming operations. Therefore, in some embodiments, it is desirable to register the coordinates of planted crops on a map. By doing so, the task of identifying at least some of the weeds becomes much simpler because the locations of the crops are known in advance.

Cost, although always a consideration, may not necessarily be a limiting factor, because the treatment may only be needed once or twice a year and may therefore allow cost-sharing between many fields and/or customers. Additionally, as crop prices have risen significantly in recent years, incremental improvements in yield and crop quality may more significantly affect farmers' profits.

In some embodiments, high-intensity light sources (e.g., a laser or an array of lasers, which may be coherent or incoherent) may allow long-range (e.g., a kilometer or further) killing or damaging of plant material using manageable apertures (e.g., 30 cm or smaller for visible or near-infrared light). Using these ranges, it may be desirable to assemble a system that enables high-intensity light sources to be stationed (e.g., temporarily, semi-permanently, or permanently) along the border of a field to target weeds. Such a light source would have sufficient intensity capable of killing or damaging a plant material target whether it be the leaves, the stems, the flowers, the root ball, the seedpods, or other portions. In certain embodiments, modern laser firing control methodologies such as inertial platforms, laser ranging, real-time imaging and/or remote sensing, and the like are used.

In an embodiment, vehicles, such as unmanned vehicles (e.g., unmanned aircraft vehicles (UAVs) or unmanned ground vehicles, such as wheeled or tracked vehicles, stilted walking vehicles, ground-scurrying vehicles, etc.), robots, and/or other light-weight transportable systems, are used in combination with a light source, to attack individual weeds. In some embodiments, the vehicles, in combination with the light source, are configured to specifically attack portions of weeds, such as the weeds' seedpods. For the purposes of the present disclosure, the term “vehicle” may include any type of object capable of carrying an item (e.g., a light redirector, a light source, a sensor, etc.), and the term “robot” may include any type of machine capable of automatically or semi-automatically carrying out a series of actions. Therefore, in some circumstances, an object may be both a vehicle and a robot.

In an embodiment, manned vehicles, unmanned vehicles, robots and/or other light-weight transportable systems are configured to transmit the light source to various locations to attack individual weeds. However, in some circumstances, it is beneficial to not have a vehicle and/or robot transporting the light source (e.g., a laser) because of its size, weight, and power requirements. To that end, in some embodiments, attacks may be carried out by using optics on a vehicle and/or robot to redirect a laser beam or other high-intensity light from a light source platform to a plant material target. Laser or high-intensity light redirection may allow more localized targeting to be achieved, may provide a better angle for targeting the plant material target, and/or may provide reduced obstruction by non-target plants. Accordingly, an advantage to localized targeting that is available by using certain types of vehicles and/or robots having light redirection optics is that weeds can be attacked even when they are not directly visible by the light source. To the extent that the weeds may be targeted at any time, weeds may be targeted when they are first identified, when they reach a predetermined height, when the seedpods reach a predetermined size, or when the seedpods are about to burst, among other times.

In addition to a high-intensity light source, some embodiments utilize, separately or simultaneously, other techniques to kill or damage weeds. For example, some embodiments utilize chemicals such as herbicides, which may be delivered to certain plant material targets (e.g., seedpods) in addition to or instead of the high-intensity light source. For example, certain weeds may be too large to efficiently kill using a high-intensity light source. Accordingly, the system may apply an herbicide to the weed as a complimentary, alternative, or redundant means to kill or damage the weed. In certain embodiments, certain herbicides are chemically tailored for seed killing in particular. Other embodiments utilize mechanical systems (e.g., cultivators), electrical systems, and/or thermal systems in separately from or simultaneous with the high-intensity light source.

In some embodiments, unmanned vehicles, robots, and/or light-weight transportable systems are configured to perform various tasks in addition to or other than weed control and eradication. For example, some embodiments employ plant identification/health vehicles and/or robots to mark plants for eradication and/or other actions (e.g. insect/pest control). Other embodiments may include vehicles and/or robots to disperse fertilizer or seeds. Further embodiments may utilize any of various types of sensors to collect data regarding plants and/or the surrounding environment.

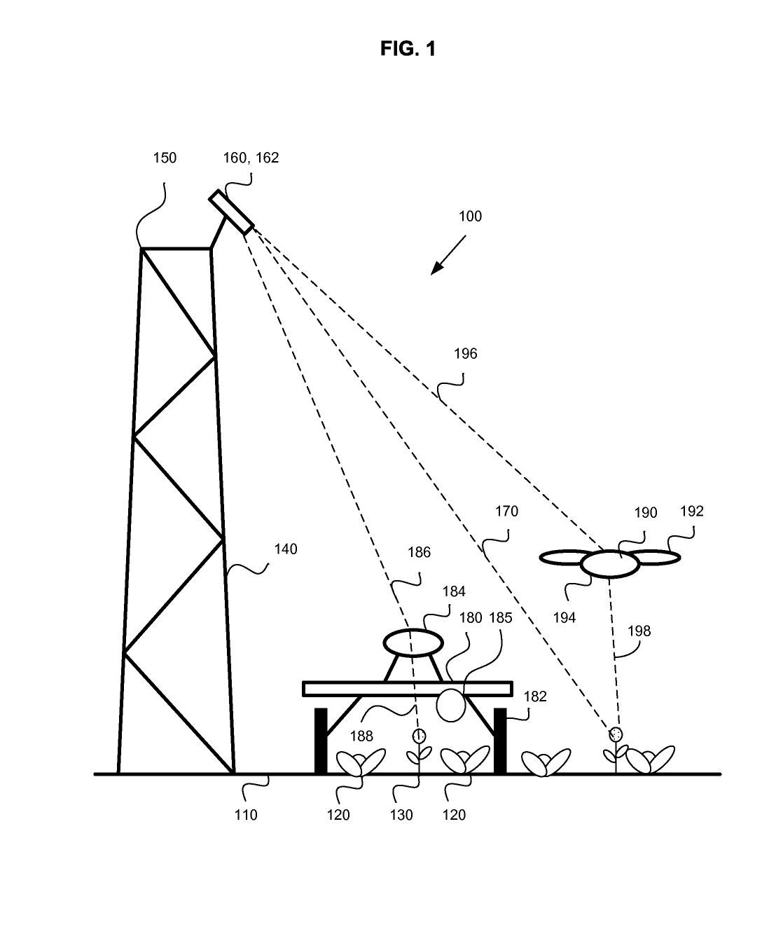

Several alternative embodiments of plant material targeting apparatus are illustrated in FIGS. 1-6. The plant material targeting apparatus of FIGS. 1-6 is used to eradicate and control weeds 130 or other plants on the ground such as in crop field 110 or other area having crops 120 or other desirable plants. In some embodiments, the plant material targeting apparatus may use short-range killing techniques from a mobile ground vehicle. In other embodiments, the plant material targeting apparatus may use long-range killing techniques (e.g., high-intensity light beams) from a fixed or remotely moving (e.g., via air or ground) platform. In some embodiments, the plant material targeting apparatus may interchangeably use long-range killing techniques when a direct line-of-sight is available between the light source and the plant material target, and may use light redirecting optics when a line of sight is not available between the light source and the plant material target, or if the range between the light source and the plant material target is greater than a predetermined amount.

For the sake of clarity and brevity, various embodiments are described herein with respect to high-intensity light sources and high-intensity light beams. However, the high-intensity light sources may include various types of light sources. The high-intensity light source may be configured to emit at least one of visible light, infrared light, and ultraviolet light. In some embodiments, even longer wavelengths of electromagnetic radiation (e.g. microwave, millimeter or submillimeter radiation) which can be transmitted through the air and reflected and focused by suitable quasi-optical elements may be used in place of UV, visible, and/or infrared light. The high-intensity light source may include a laser or a laser array. The laser or laser array may include a diode laser, a carbon dioxide (CO2) laser, a fiber laser, a diode-pumped solid state (DPSS) laser, or other types of lasers. In some embodiments, the light source includes a quasi-optical source (e.g., a source configured to produce waves having a frequency of between 0.3 and 3 terahertz and a wavelength of between 1 mm and 1 μm). In some embodiments, the light source includes optics, such as a beam expander, for transmitting the light beam to the redirector platform. In some embodiments, the light source includes a light concentrator and/or an incoherent light collector not enabled for redirection. In some embodiments, the focused light may damage or destroy plant material by localized heating. In other embodiments, plant material may be damaged or destroyed by other photophysical or photochemical effects, such as bleaching, for example.

Referring now to FIG. 1, plant material targeting apparatus 100 used to eradicate and control weeds 130 in crop field 110 having crops 120 is illustrated. In one embodiment, light source platform structure 140 is used to support light source platform 150 holding high-intensity light source 160 (e.g., laser source). In some embodiments, structure 140 and light source platform 150 are moved, placed, and/or erected outside of crop field 110 (e.g., outside of a crop growing area of crop field 110) or alternatively at various locations within crop field 110 (e.g., within a crop growing area of crop field 110) or other area of interest. Structure 140 provides sufficient height to high-intensity light source 160 (e.g., laser source), which is able to provide high-intensity light beam 170 (e.g., laser beam) directly onto at least a portion of a plant material target (e.g., weed 130).

In another embodiment, light source platform 150 with high-intensity light source 160 (e.g., laser source) provides high-intensity light beam 186 (e.g., laser beam) to light redirection platform 180 separate from light source platform 150. Light source 160 may include a light transmitter configured to transmit light beam 186 to light redirector 184. The light transmitter may include various types of optics (e.g., mirrors and lenses) to modify light beam 186. Light redirector 184 may be configured to receive light beam 186 (e.g., laser beam) from high-intensity light source 160 (e.g., laser source) through free-space and to redirect light beam 186 (e.g., laser beam) toward a plant material target (e.g., weed 130). In one embodiment, light redirector 184 includes a single positionable mirror. In another embodiment, light redirector 184 includes a mirror train including multiple positionable mirrors. For example, in one embodiment, the mirror train includes a first mirror that is positionable such that the first mirror faces light source 140. Light beam 186 may bounce off of the first mirror and off of a second mirror of the mirror train, such that light beam 186 is in a fixed position relative to light source platform 150. The mirror train may further include a third mirror positionable to direct the fixed beam to a target. In another embodiment, light redirector 184 includes optics, such as lenses and/or mirrors (e.g., curved mirrors), to modify light beam 186. For example, optics may be used to capture light beam 186 and reduce or expand a diameter of light beam 186 before light beam 186 enters light redirector 184. In various embodiments, optics are used to focus light beam 186 to a small diameter to concentrate the energy of light beam 186 to a small target.

In some embodiments, light source platform 150 and light redirection platform 180 are configured for relative motion therebetween. Light redirector 184 may be coupled to light redirection platform 180. In some embodiments, light redirection platform 180 is a ground-based mobile platform. In some embodiments, light redirection platform 180 includes a wheeled or tracked vehicle (e.g., a tractor or a truck), a legged vehicle, a pedestal-walking vehicle, a cable-carried vehicle, etc. In some embodiments, light redirection platform 180 is configured to be carried by a human and/or by an animal.

In another embodiment, light source platform 150 with high-intensity light source 160 (e.g., laser source) may provide light beam 196 (e.g., laser beam) to airborne light redirection platform 190 separate from light source platform 150. Light redirector 194 may be coupled to light redirection platform 190. Light redirector 194 may be configured to receive light beam 196 (e.g., laser beam) from high-intensity light source 160 (e.g., laser source) and redirect light beam 198 (e.g., laser beam) toward a plant material target (e.g., weed 130).

In some embodiments, high-intensity light source 160 (e.g., laser source) may include a high-intensity light generating device and a high-intensity light delivery device (e.g., a light transmitter). The generating device and the delivery device may be encompassed in a common light source device, or they may be discrete components. For example, in some embodiments, the generating device may at least partially include a fiber optic cable and/or may be positioned off of light source platform 150.

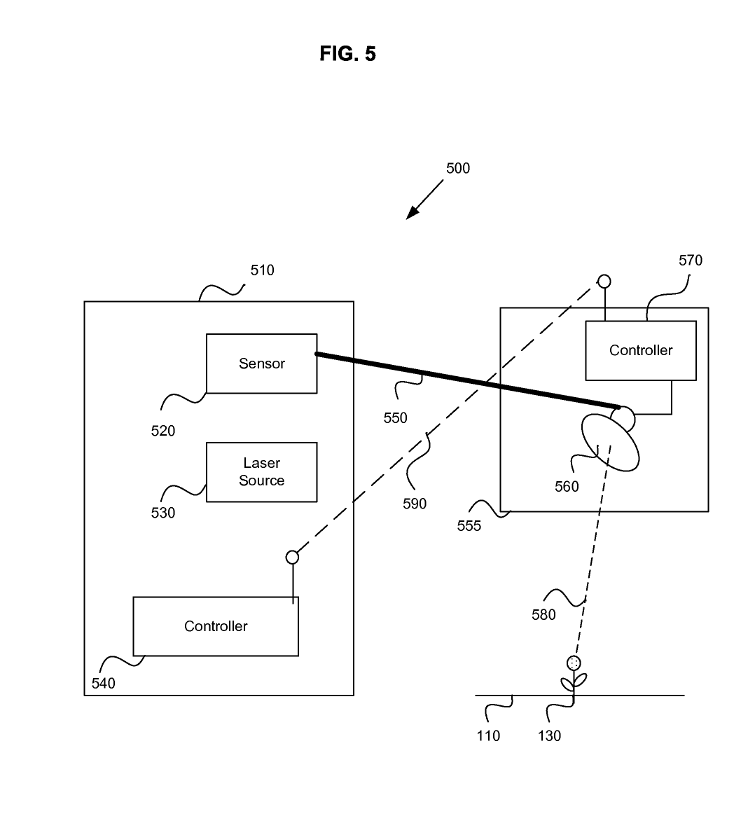

In another embodiment, a control system (e.g., control system 500 of FIG. 5) may receive information representative of the location of a plant material target (e.g., weed 130). The control system may provide a control signal to light redirector 184, 194 to cause light redirector 184, 194 to receive light beam 186, 196 (e.g., laser beam) from high-intensity light source 160 (e.g., laser source) and to redirect light beam 188, 198 (e.g., laser beam) toward a plant material target (e.g., weed 130). In some embodiments, the control system is configured to determine a type of plant material to target. For example, the control system may identify and distinguish crop 120 and weed 130. In addition, the control system may identify particular types of material on weed 130 to target, such as seedpods, leaves, and the like. The control system may also control a shutter or optical switch to turn light beam 186, 196 on and off.

In some embodiments, light redirector 184, 194 is configured to redirect light beam 186, 196 (e.g., laser beam) toward more than one plant material target 130 before moving light redirection platform 180, 190, and subsequently moving light redirection platform 180, 190.

For example, light redirection platform 180, 190 may be moved without moving light source platform 150. In other examples, light redirection platform 180, 190 may be moved within crop field 110 and light source platform 150 may be located outside of crop field 110.

According to an embodiment, apparatus 100 may be configured to operate in a plant material damaging mode and in a plant material targeting mode. In the plant material damaging mode, high-intensity light source 160 may be configured to provide a high-intensity light to weed 130 to cause damage (e.g., to kill) weed 130. In the plant material targeting mode, illumination source 162 may be configured to provide light for reasons other than killing weed 130. In one embodiment, apparatus 100 is configured to use illumination source 162 to first illuminate weed 130 and then to utilize high-intensity light source 160 (e.g., a laser) to kill weed 130. In some embodiments, the plant material targeting mode is used for identification (e.g., via remote sensing, imaging, spectrometry, etc.) of weed 130. For example, the plant material targeting mode may be used to determine and store the location (e.g., in memory) of a plurality of plant material targets 130 and to use the plant material damaging mode in accordance with the stored locations of the plant material targets 130. In general, illumination can be passive (e.g., configured for wavelength-dependent reflectivity and/or absorption) or can be active (e.g., configured to vaporize or excite part of the plant and observe the results). High-intensity light source 160 and illumination source 162 may be may be the same device or different devices and/or optical systems. For example, in an embodiment, high-intensity light source 160 includes a laser and illumination source 162 includes a white light source.

In some embodiments, illumination (e.g., laser illumination) can be used for aimpoint control. For example, aimpoint control may include scanning a low-intensity beam (e.g., illumination beam) and firing a high-intensity beam (e.g., kill beam) when a target is identified. Aimpoint control may also include varying the focus of the low-intensity beam, and firing the high-intensity beam when a desired spot size is identified. In some embodiments, the illumination mode may be used for damage assessment. For example, damage assessment may be used to control ongoing or future firing. In other words, damage may be assessed while light source 160 (e.g., laser source) is being fired or between discrete firing events. In certain embodiments, the system is automatically or manually controlled.

In some embodiments, light source 160 (e.g., laser source) is configured to be switchable between a use state and a non-use state. For example, light source 160 (e.g., laser source) may be configured to provide a light beam (e.g., laser beam) during the use state and to not provide a light beam (e.g., laser beam) during the non-use state. In some embodiments, light source 160 may cover or retract optical surfaces in the non-use state, and to expose optical surfaces only in the use state. In some embodiments, light source platform structure 140 is configured to cause a change in the height of light source platform 150 when going from the non-use state to the use state. In further embodiments, light source platform 150 may include a mechanical stabilization system that is deployed during the use state but that is not used during the non-use state.

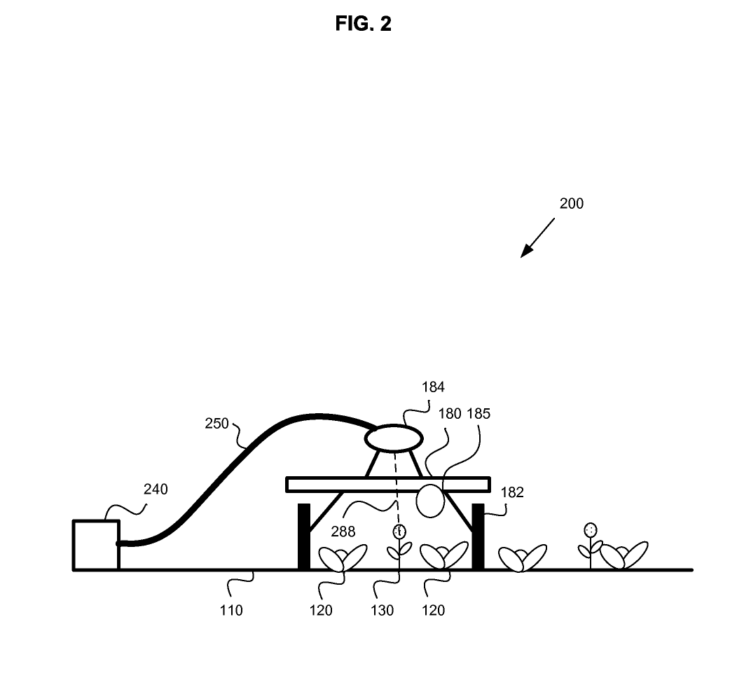

Turning to FIG. 2, plant material targeting apparatus 200 is illustrated according to one embodiment. Apparatus 200 is similar to apparatus 100 and may include, in various embodiments, components similar to those described above with respect to apparatus 100. In one embodiment, high-intensity light source 240 may provide a high-intensity light or laser to light redirection platform 180 via optical fiber or conduit 250. Light redirector 184 may be coupled to light redirection platform 180. Light redirector 184 may be configured to receive the high-intensity light (e.g., laser) beam from light source 240 and redirect light beam 288 (e.g., laser beam) toward a plant material target (e.g., weed 130). In some embodiments, light redirector 184 is configured to expand light beam 288 (e.g., laser beam) and focus light beam 288 (e.g., laser beam) onto the plant material target (e.g., weed 130). In certain embodiments, light redirector 184 may also be configured to perform various beam modification techniques on light beam 288 (e.g., laser beam), such as mode cleanup, aperturing, and/or filtration, among others.

In certain embodiments, light redirection platform 180 is a mobile vehicle, such as a ground vehicle or an aircraft. The vehicle may be manned or unmanned. In addition, light redirection platform 180 may be carried by a person or animal. Light source 240 may be mobile or stationary. In some embodiments, light source 240 is carried by light redirection platform 180.

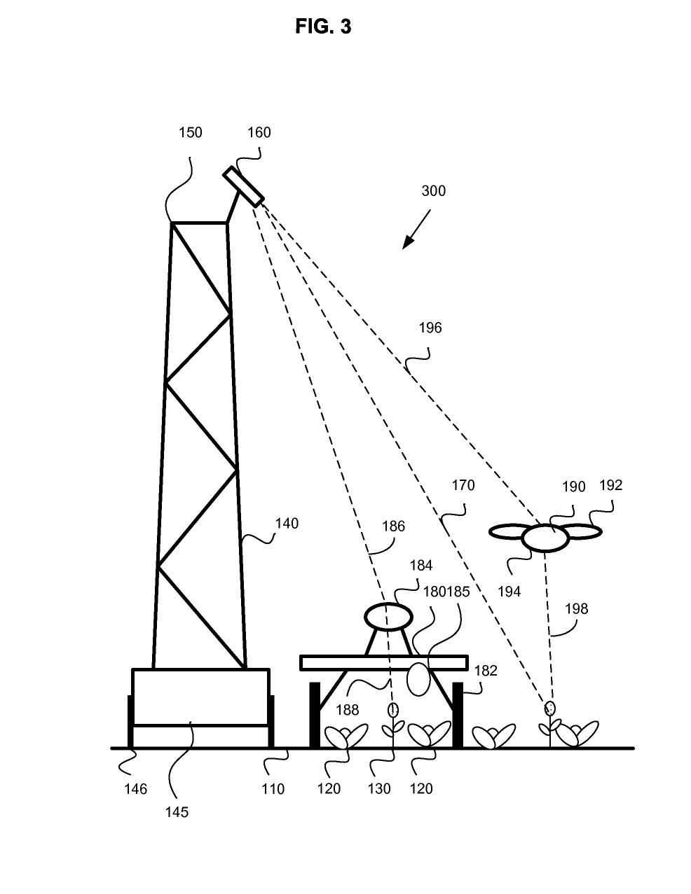

Turning to FIG. 3, a plant material targeting apparatus 300 is illustrated according to one embodiment. Apparatus 300 is similar to apparatus 100 and may include, in various embodiments, components similar to those described above with respect to apparatus 100. In one embodiment, light source platform structure 140 is used to support platform 150 holding high-intensity light source 160 (e.g., laser source). Structure 140 includes vehicle 145 with wheels 146 to allow platform 150 to be moved either within or outside of crop field 110. For example, light source platform 150 may be a mobile platform, such as a ground-based mobile platform. In other embodiments, light source platform 150 may be an airborne mobile platform. In some embodiments, light source platform 150 is self-propelled while in other embodiments, light source platform 150 is towed, for example, by a tractor. In some embodiments, light source platform 150 is located within or outside of crop field 110.

In some embodiments, apparatus 300 includes light redirector 184 coupled to ground-based light redirection platform 180, which may be fixed or mobile. For example, light source 160 (e.g., laser source) may be configured to provide light beam 186 (e.g., laser beam) to ground-based light redirector 184 to redirect beam 188 onto the plant material target (e.g., weed 130). Additionally or alternatively, apparatus 300 may include light redirector 194 coupled to airborne light redirection platform 190. For example, light source 160 (e.g., laser source) may be configured to provide light beam 196 (e.g., laser beam) to airborne light redirector 194 to redirect beam 198 onto the plant material target (e.g., weed 130). Light redirection platforms 180, 190 may be located within or outside of crop field 110.

In some embodiments, both of light source platform 150 and at least one of light redirection platforms 180, 190 are mobile. Additionally, in some embodiments, light source platform 150 and at least one of light redirection platforms 180, 190 are physically connected. For example, light source platform 150 may include a tractor-mounted laser that is configured to send multiple beams to light redirection platform 180, 190, which may include multiple beam directors on a lateral boom. In other embodiments, both of the light source platform 150 and at least one of light redirection platforms 180, 190 platforms are fixed. For example, light source platform 150 may include a ground-mounted laser that is configured to send a beam to light redirection platform 180, 190, which may include a tower-mounted beam director. In some embodiments, apparatus 300 is used to identify and attack specific parts of weeds 130 (e.g., stem, seeds, leaves, and other parts). Apparatus 300 may be used to kill weeds 130 at specific times within a growth cycle, such as at first sprouting, at a set height, before seed release, and at other times.

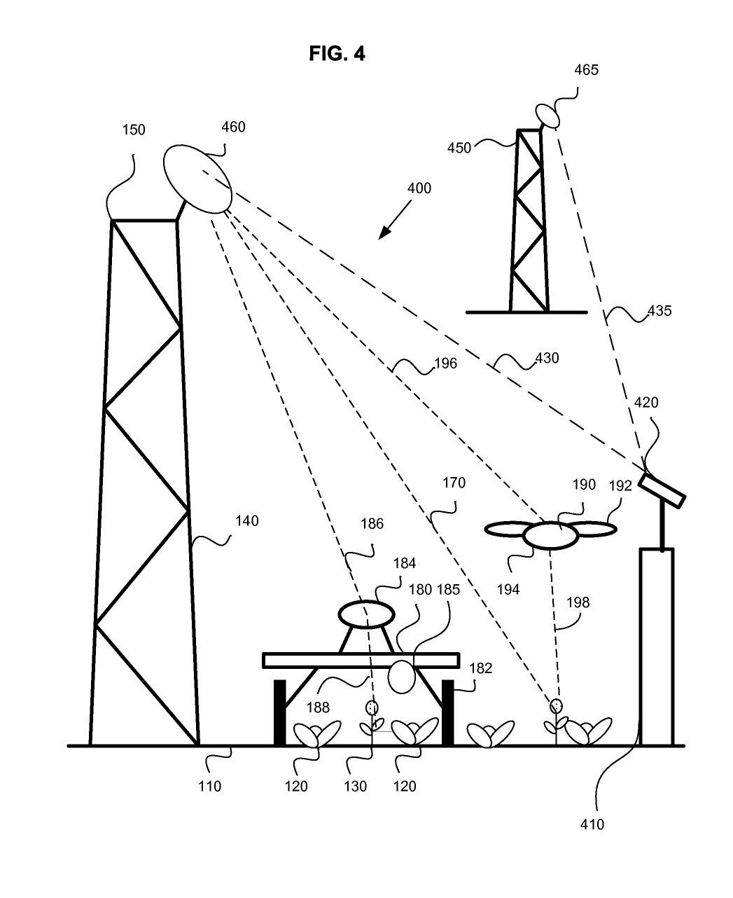

Turning to FIG. 4, plant material targeting apparatus 400 is illustrated according to one embodiment. Apparatus 400 is similar to apparatus 100 and may include, in various embodiments, components similar to those described above with respect to apparatus 100. In one embodiment, high-intensity light platform 410 is used to support high-intensity light source 420 (e.g., laser source). Apparatus 400 may be configured to deliver light beam 430 (e.g., laser beam) from light source platform 410 to first local platform 150 for redirection onto a plant material target (e.g., weed 130). In some embodiments, laser delivery can be via a free-space link through the air. First local platform 150 can redirect beam 430 (e.g., laser beam) via first beam director 460 (e.g., a mirror or a lens). In certain embodiments, redirection may or may not be accompanied by beam modification (focusing, defocusing, mode cleanup, aperturing, filtration, etc.). In certain embodiments, beam director 460 is configured to redirect beam 170 (e.g., laser beam) directly onto a plant material target (e.g., weed 130). In other embodiments, first beam director 460 is configured to redirect beam 186 (e.g., laser beam) to light redirector 184, which may be further configured to redirect beam 188 (e.g., laser beam) toward a plant material target (e.g., weed 130).

In another embodiment, plant material targeting apparatus 400 is configured to deliver light beam 435 (e.g., laser beam) from light source platform 410 to second local platform 450 for redirection onto a weed, for example, via second beam redirector 465. In one embodiment, second local platform 450 is located in another field, which may be spaced far apart (e.g., up to 1 km or further) from light source platform 410.

In some embodiments, light source platform 410 is located within or outside of crop field 110. In some embodiments, light source platform 410 and/or at least one of first and second local platforms 150, 450 are mobile between firing events. For example, in an embodiment, second local platform 450 is configured to be positioned at an end of a row of crop field 110 and first local platform 150 may be configured to travel along the row. Second beam director 465 of second local platform 450 may be configured to receive light beam 435 from light source 420 and redirect light beam 435 to first local platform 150, where light beam 435 may be redirected toward weed 130. Second local platform 450 may be configured to travel from row to row in crop field 110, and first local platform 150 may be configured to travel along each respective row at which second local platform 450 is positioned.

In some embodiments, all or part of light source platform 410 and/or at least one of first and second local platforms 150, 450 are elevated. For example, in some embodiments, light source 420 is positioned near the ground and is configured to deliver light beam 430, 435 (e.g., laser beam), for example, via air, fiber, conduit, or other media, to one or more elevated beam directors, such as first beam director 460 of first local platform 150 and second beam director 465 of second local platform 450, respectively. In some embodiments, at least one of light source platform 410 and first and second local platforms 150, 450 are also used for weed imaging and/or remote sensing, as well as identification. In other embodiments, light source 420 (e.g., via a control system) inputs targeting information from another source.

Turning to FIG. 5, a block diagram of control system 500 for a plant material targeting apparatus is illustrated, according to one embodiment. Control system 500 includes high-intensity light control system 510, which may include sensor 520, high-intensity light source 530, memory 535, and high-intensity light controller 540. Control system 500 may also include redirector control system 555, which may include beam director 560 and redirector controller 570. Sensor 520 may be configured to distinguish plant material targets 130 from desired plant material and to identify the location of plant material targets (e.g., weed 130).

In some embodiments, control system 500 memory 535 includes data relating to characteristics of one or more plants. Control system 500 may be configured to distinguish plant material target 130 from a predetermined plant material based on stored plant characteristics data. For example, plant material targets 130 (e.g., weed seedpods) may be identified by performing various image processing techniques, such as image recognition, spectrometry, among others, on information captured by sensor 520.

Control system 510, via sensor 520, may be configured to provide information 550 representative of the location of plant material target (e.g., weed 130) to beam director 560. Additionally or alternatively, high-intensity light controller 540 may be configured to provide control signal 590 to redirector controller 570 to cause redirection of beam 580 to plant material target 130. In one embodiment, sensor 520 includes a camera. In another embodiment, sensor 520 includes a camera and an image recognition system. In a further embodiment, sensor 520 includes a spectral filter of a multicolor camera.

In some embodiments, control system 500 is configured for a high intensity mode and a low intensity mode. For example, control system 500 may be configured to use the low intensity mode to determine and store the location of a multiplicity of plant material targets 130 and to use the high intensity mode to aim and fire the high-intensity laser at the stored locations of plant material targets 130. In another embodiment, control system 500 may switch between a targeting mode configured to achieve and confirm plant material target 130 and a damaging mode to attempt to damage plant material target 130. The damaging mode and the targeting mode may both use at least a part of control system 500 (e.g., a single beam direction system). In some embodiments, high-intensity light source 530 is used for the targeting mode and an illumination source (not shown) is used for the plant material damaging mode. Light source 530 and the illumination source may use at least some of the same beam optics.

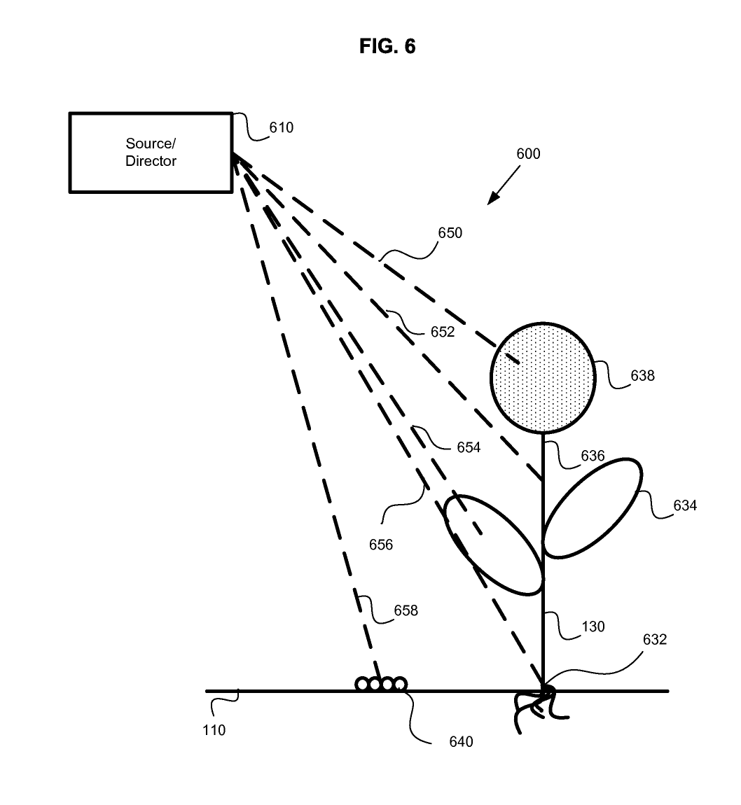

Turning to FIG. 6, plant material targeting apparatus 600 is illustrated according to one embodiment. Apparatus 600 is similar to apparatus 100 and may include, in various embodiments, components similar to those described above with respect to apparatus 100. Apparatus 600 may include source/director 610 to identify and attack specific parts of plant material target (e.g., weed 130). In some embodiments, source/director 610 identifies specific parts of plant material target 130 by image recognition, by spectrometry, or by other techniques. For example, according to various embodiments, source/director 610 may be configured to direct or redirect at least one of (1) beam 650 to seedpod 638 of plant material target 130; (2) beam 652 to stem 636 of plant material target 130; (3) beam 654 to leaves 634 of plant material target 130; (4) beam 656 to roots 632 of plant material target 130; and (5) beam 658 to detached seedpod 640 of plant material target 130. In addition, source/director 610 may be configured to kill plant material target 130 at specific times within a growth cycle, such as at first sprouting, at a set height, before seed release, and at other times.

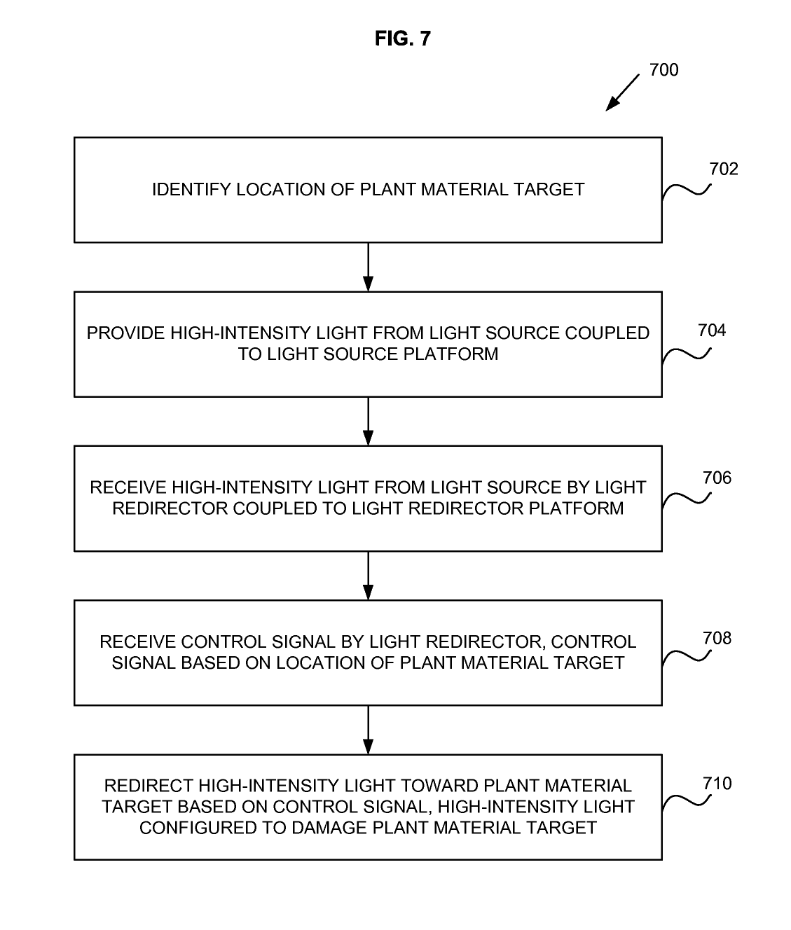

Turning to FIG. 7, a flow diagram illustrating a method of eradicating unwanted plants 700 is shown according to one embodiment. In some embodiments, method 700 is implemented by one or more of apparatus 100, 200, 300, 400, 500, and 600.

At 702, the location of a plant material target (e.g., weed 130) is identified. For example, the location of plant material targets 130 (e.g., weed seedpods) may be identified by performing various image processing techniques, such as image recognition, spectrometry, among others, on information captured by a sensor (e.g., sensor 520 of FIG. 5).

At 704, a high-intensity light is provided from a high-intensity light source coupled to a light source platform. For example, in one embodiment, high-intensity light beam 186 (e.g., laser beam) is provided from high-intensity light source 160 (e.g., laser source) on light source platform 150.

At 706, the high-intensity light is received from the high-intensity light source by a light redirector coupled to a redirector platform. For example, in one embodiment, high-intensity light beam 186 (e.g., laser beam) is received from high-intensity light source 160 (e.g., laser source) by light redirector 184 coupled to light redirection platform 180.

At 708, a control signal is received by the light redirector. The control signal is based on the location of the plant material target. For example, in one embodiment, the control system (e.g., control system 500 of FIG. 5) may provide a control signal to the redirector (e.g., light redirector 184 coupled to light redirection platform 180).

At 710, the high-intensity light is redirected toward the plant material target based on the control signal. The high-intensity light is configured to damage the plant material target. For example, in an embodiment, the redirector 184 is configured to aim the high-intensity light (e.g., light beam 188) at the plant material target (e.g., weed 130) to damage the plant material target.

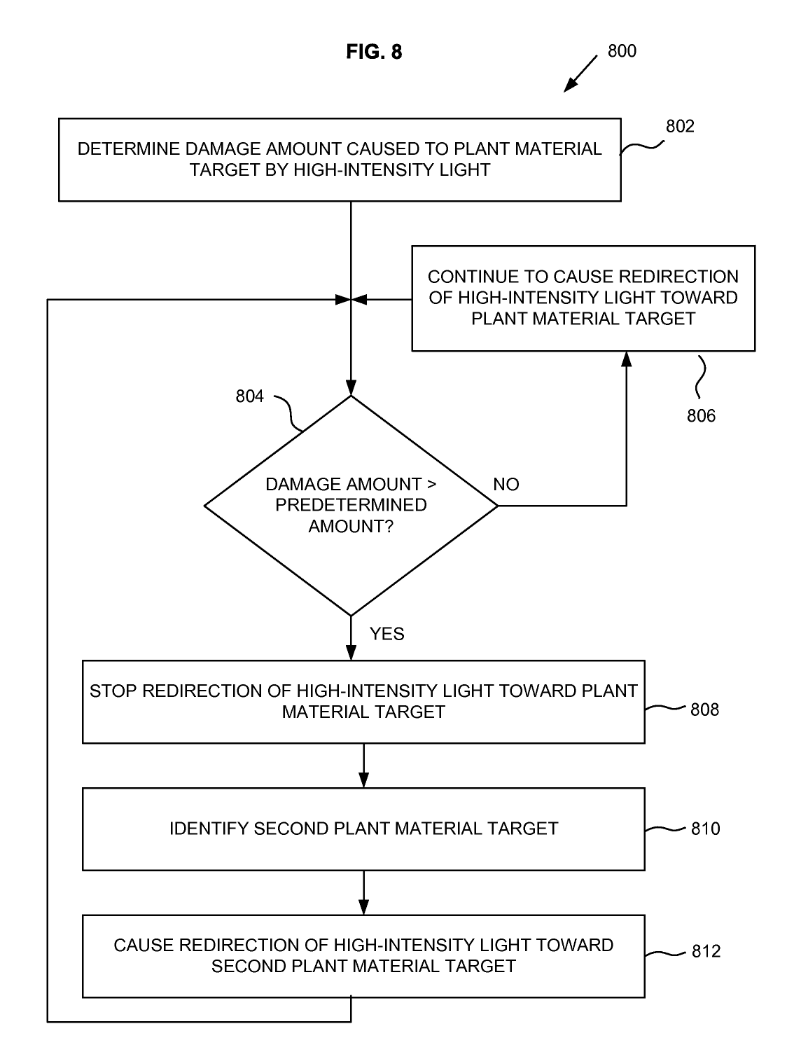

Turning to FIG. 8, a flow diagram illustrating a method of eradicating unwanted plants 800 is shown according to one embodiment. In some embodiments, method 800 is implemented by one or more of apparatus 100, 200, 300, 400, 500, and 600. The method 800 may be performed in conjunction with the method 700 of FIG. 7.

At 802, a damage amount caused to a plant material target (e.g., weed 130) by a high-intensity light (e.g., light beam 188) is determined. For example, the damage amount may be determined by performing various image processing techniques, such as image recognition, spectrometry, among others, on information captured by a sensor (e.g., sensor 520 of FIG. 5). The damage amount may be a relative value used to quantify an amount of damage to the weed 130, and may be based on various factors, such as changes in color.

At 804, it is determined whether the damage amount determined at 802 exceeds a predetermined amount. According to an embodiment, the predetermined amount may indicate an amount of damage to weed 130 to cause weed 130 to die or to be incapable of reproduction, for example.

If at 804 it is determined that the damage amount does not exceed a predetermined amount, the method continues to 806. At 806, high-intensity light is continued to be redirected toward the plant material target.

If it is instead determined at 804 that the amount of damage does exceed the predetermined amount, the method continues to 808. At 808, redirection of high-intensity light toward the plant material target is stopped. In some embodiments, this is effected by stopping the transmission of light from high-intensity light source 160.

At 810, a second plant material target is identified. For example, the second plant material targets may be identified using the same techniques as those used to identify the first plant material target.

At 812, the high-intensity light is redirected toward the second plant material target. In some embodiments, high-intensity light source 160 is configured to again provide light beam 188 to redirector 184, and redirector 184 is configured to redirect the light beam 188 toward the plant material target.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A plant material targeting apparatus, comprising:
a light source platform;
a light source coupled to the light source platform, the light source configured to provide a high-intensity light;
a light transmitter coupled to the light source, the light transmitter configured to transmit the high-intensity light to a light redirector;
a light redirection platform separate from the light source platform, the light redirector being coupled to the light redirection platform, wherein the light redirector is configured to receive the high-intensity light from the light transmitter and redirect the high-intensity light toward a plant material target to damage the plant material target; and
a control system configured to receive information representative of the location of the plant material target and configured to provide a control signal to the light redirector to cause redirection of the high-intensity light to the plant material target.

2-5. (canceled)

6. The apparatus of claim 1, wherein the control system is configured to determine a type of plant material to target.

7. The apparatus of claim 1, wherein the control system is configured to distinguish a plant material target from a predetermined plant material.

8. The apparatus of claim 1, wherein the light source platform and the light redirection platform are configured for relative motion therebetween.

9. The apparatus of claim 8, wherein the light redirection platform is movable within a field containing the plant material target.

10. The apparatus of claim 8, wherein the light redirection platform includes an airborne platform.

11. The apparatus of claim 8, wherein the light redirection platform includes a wheeled or tracked vehicle.

12-16. (canceled)

17. The apparatus of claim 1, wherein the light redirector includes optics configured to focus the high-intensity light toward the plant material target.

18-25. (canceled)

26. The apparatus of claim 1, further comprising a sensor configured to provide the information representative of the plant material target.

27-36. (canceled)

37. The apparatus of claim 26, wherein at least one of the light source and the light redirector is switchable between a plant material damaging mode and a plant material targeting mode.

38-39. (canceled)

40. The apparatus of claim 37, wherein the plant material targeting mode includes determining and storing locations of a multiplicity of plant material targets, and wherein the plant material damaging mode includes damaging the plant material targets based on the stored locations of the plant material targets.

41. The apparatus of claim 26, wherein the sensor is further configured to determine whether the high-intensity light hit the plant material target.

42. The apparatus of claim 26, wherein the sensor is further configured to determine a damage amount caused to the plant material target by the high-intensity light.

43. The apparatus of claim 42, wherein the control system is configured to:
if the damage amount is less than a predetermined amount, continue to cause redirection of the high-intensity light toward the plant material target; and
if the damage amount is greater than the predetermined amount,
stop redirection of the high-intensity light toward the plant material target,
identify a second plant material target, and
cause redirection of the high-intensity light toward the second plant material target.

44. A method of eradicating unwanted plants, comprising:
identifying a location of a plant material target;
providing a high-intensity light from a light source coupled to a light source platform;
receiving the high-intensity light from the light source by a light redirector coupled to a light redirection platform;
receiving a control signal by the light redirector, the control signal based on the location of the plant material target; and
redirecting the high-intensity light toward the plant material target based on the control signal, the high-intensity light configured to damage the plant material target.

45-48. (canceled)

49. The method of claim 44, further comprising moving the light redirection platform relative to the light source.

50-54. (canceled)

55. The method of claim 49, further comprising redirecting the high-intensity light toward more than one plant material target before moving the light redirection platform.

56-59. (canceled)

60. The method of claim 44, wherein the high-intensity light is redirected via a mirror train, the mirror train including at least two positionable mirrors.

61. The method of claim 44, further comprising focusing, using optics, the high-intensity light toward the plant material target.

62-64. (canceled)

65. The method of claim 44, further comprising providing, by a sensor, information representative of the plant material target.

66-75. (canceled)

76. The method of claim 44, further comprising switching at least one of the light source and the light redirector between a plant material damaging mode and a plant material targeting mode.

77. The method of claim 76, wherein the plant material targeting mode includes at least one of multi-wavelength and broadband sensing.

78. The method of claim 76, wherein the light source is configured to operate using higher power in the plant material damaging mode relative to the plant material targeting mode.

79. The method of claim 76, further comprising:
determining and storing, during the plant material targeting mode, the location of a plurality of plant material targets; and
aiming and firing the high intensity light source, during the plant material damaging mode, at the stored locations of the plant material targets.

80. The method of claim 44, further comprising identifying a predetermined part of the plant material target, wherein the high-intensity light is redirected toward the predetermined part.

81. (canceled)

82. The method of claim 44, further comprising determining a damage amount caused to the plant material target by the high-intensity light.

83. The method of claim 82, further comprising:
if the damage amount is less than a predetermined amount, continuing to cause redirection of the high-intensity light to the plant material target; and
if the damage amount is greater than the predetermined amount,
stopping redirection of the high-intensity light to the plant material target,
identifying a second plant material target, and
causing redirection of the high-intensity light to the second plant material target.

84. An apparatus for eradicating unwanted plants, comprising:
a means for identifying a location of a plant material target;
a means for providing a high-intensity light from a light source coupled to a light source platform;
a means for receiving the high-intensity light from the light source by a light redirector coupled to a light redirection platform;
a means for receiving a control signal by the light redirector, the control signal based on the location of the plant material target; and
a means for redirecting the high-intensity light toward the plant material target based on the control signal.

85-87. (canceled)

88. The apparatus of claim 84, further comprising a means for moving the light redirection platform relative to the light source platform.

89-102. (canceled)

103. The apparatus of claim 84, further comprising a means for sensing information representative of the plant material target.

104-112. (canceled)

113. The apparatus of claim 84, wherein at least one of the means for providing the high-intensity light and the means for redirecting the high-intensity light is configured to be switchable between a plant material damaging mode and a plant material targeting mode.

114. The apparatus of claim 113, wherein the plant material targeting mode includes determining and storing a location of a plurality of plant material targets, and wherein the plant material damaging mode includes operating the means for redirecting the high-intensity light in accordance with the stored locations of the plurality of plant material targets.

115. The apparatus of claim 113, wherein plant material targeting mode includes identifying a predetermined part of the plant material target, and wherein the plant material damaging mode includes operating the means for redirecting the high-intensity light so as to redirect the high-intensity light toward the predetermined part.

116. (canceled)

117. The apparatus of claim 103, wherein the means for sensing is further configured to determine a damage amount caused to the plant material target by the high-intensity light.

118. The apparatus of claim 117, wherein:
if the damage amount is less than a predetermined amount, the means for providing the high-intensity light is configured to continue to provide the high-intensity light, and the means for redirecting is configured to continue to redirect the high-intensity light toward the plant material target; and
if the damage amount is greater than the predetermined amount,
the means for providing is configured to stop providing the high-intensity light,
the means for identifying is configured to identify a location of a second plant material target, and
the means for providing is configured to provide the high-intensity light, and
the means for redirecting is configured to cause redirection of the high-intensity light toward the second plant material target.
